(19) United States
(12) Patent Application Publication
(10) Pub. No.: US 2026/0277385 A1
(43) Pub. Date: Sep. 17, 2026

(54) SYSTEMS AND METHODS FOR TWO-DIMENSIONAL AND THREE-DIMENSIONAL DISPLAY

(71) Applicant: Apple Inc., Cupertino, CA (US)

(72) Inventor: Benjamin B. LOGGINS, San Francisco, CA (US)

(21) Appl. No.: 19/667,365

(22) Filed: May 4, 2026

Related U.S. Application Data
(63) Continuation of application No. 18/442,993, filed on Feb. 15, 2024, now Pat. No. 12,656,931.
(60) Provisional application No. 63/485,196, filed on Feb. 15, 2023.

(51) Int. Cl. G06F 3/04815; H04L 51/046

(52) U.S. Cl. CPC G06F 3/04815; H04L 51/046

(57) ABSTRACT

In some embodiments, an electronic device is in communication with a two-dimensional display device and/or a three-dimensional display device. In some embodiments, the electronic device displays a two-dimensional rendering or a three-dimensional rendering of a user interface element. In some situations, the electronic device uses the two-dimensional display device to display the two-dimensional rendering of the user interface element. In some situations, the electronic device uses the three-dimensional display device to display the three-dimensional rendering of the user interface element.

### CROSS-REFERENCE TO RELATED APPLICATIONS

This application is a continuation of U.S. patent application Ser. No. 18/442,993, filed Feb. 15, 2024, which claims the benefit of U.S. Provisional Application No. 63/485,196, filed Feb. 15, 2023, the contents of which are incorporated herein by reference in their entireties for all purposes.

### FIELD OF THE DISCLOSURE

Aspects of the present disclosure relate to systems and methods for displaying two-dimensional and three-dimensional renderings of a user interface element.

### BACKGROUND OF THE DISCLOSURE

Electronic devices may display user interface elements using one or more display devices.

### SUMMARY OF THE DISCLOSURE

Aspects of the present disclosure relate to systems and methods for displaying two-dimensional and three-dimensional renderings of a user interface element. In some embodiments, an electronic device is in communication with a two-dimensional display device and/or a three-dimensional display device. In some embodiments, the electronic device displays a two-dimensional rendering or a three-dimensional rendering of a user interface element. In some situations, the electronic device uses the two-dimensional display device to display the two-dimensional rendering of the user interface element. In some situations, the electronic device uses the three-dimensional display device to display the three-dimensional rendering of the user interface element.

While the foregoing and additional implementations are described herein, still other implementations are possible. Modifications within the spirit and scope of the presently disclosed technology are possible. Accordingly, the drawings and detailed description are to be regarded as illustrative in nature.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1 is an example block diagram of an electronic device according to some embodiments of the disclosure.

FIGS. 2A-2E illustrate examples of two-dimensional and three-dimensional renderings of a user interface element according to some embodiments of the disclosure.

FIGS. 3A-3C illustrate examples of preserving changes to a user interface when transitioning between displaying a two-dimensional representation of the user interface and displaying a three-dimensional rendering of the user interface in accordance with some embodiments of the disclosure.

FIG. 4 is a block diagram illustrating an example method performed by an electronic device in accordance with some embodiments of the disclosure.

### DETAILED DESCRIPTION

Aspects of the present disclosure relate to systems and methods for displaying two-dimensional and three-dimensional renderings of a user interface element. In some embodiments, an electronic device is in communication with a two-dimensional display device and/or a three-dimensional display device. In some embodiments, the electronic device displays a two-dimensional rendering or a three-dimensional rendering of a user interface element. In some situations, the electronic device uses the two-dimensional display device to display the two-dimensional rendering of the user interface element. In some situations, the electronic device uses the three-dimensional display device to display the three-dimensional rendering of the user interface element.

While the foregoing and additional implementations are described herein, still other implementations are possible. Modifications within the spirit and scope of the presently disclosed technology are possible. Accordingly, the drawings and detailed description are to be regarded as illustrative in nature.

While the foregoing and additional implementations are described herein, still other implementations are possible. Modifications within the spirit and scope of the presently disclosed technology are possible. Accordingly, the drawings and detailed description are to be regarded as illustrative in nature, and not limiting.

While some embodiments of the disclosure are described above and herein, additional and alternative embodiments are possible. Example embodiments are provided in the drawings and detailed description and are illustrative in nature. Modifications to the example embodiments are possible without departing from the scope of the disclosure.

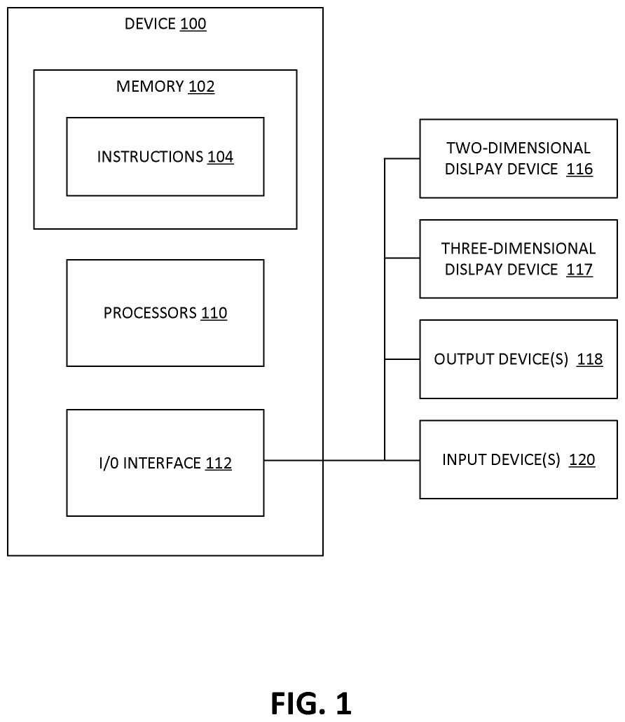

FIG. 1 is an example block diagram of an electronic device 100 according to some embodiments of the disclosure. In some embodiments, the electronic device 100 includes memory 102, one or more processors 110 and an I/O interface 112. In some embodiments, the electronic device 100 includes additional or alternative components.

In some embodiments, memory 102 of electronic device 100 includes volatile and/or non-volatile memory implemented using electronic, electromagnetic, magnetic, infrared, optical, and/or semiconductor system(s) and/or device(s). Examples of suitable memory circuitry include random access memory (RAM) devices (e.g., static random-access memory (SRAM), double-data-rate random-access memory (DDR RAM), dynamic random-access memory (DRAM), or other high-speed RAM or solid-state RAM, etc.), flash memory devices, read-only memory (ROM) devices, or erasable or electrically erasable programmable read-only memory devices (EPROM or EEPROM). Other types of memory are possible in some embodiments. In some examples, memory 102 can be separate from the one or more other components of electronic device 100 and electrically coupled to the one or more other components of electronic device 100 for read and/or write operations. In some examples, some of memory 102 can be integrated within other components of electronic device 100.

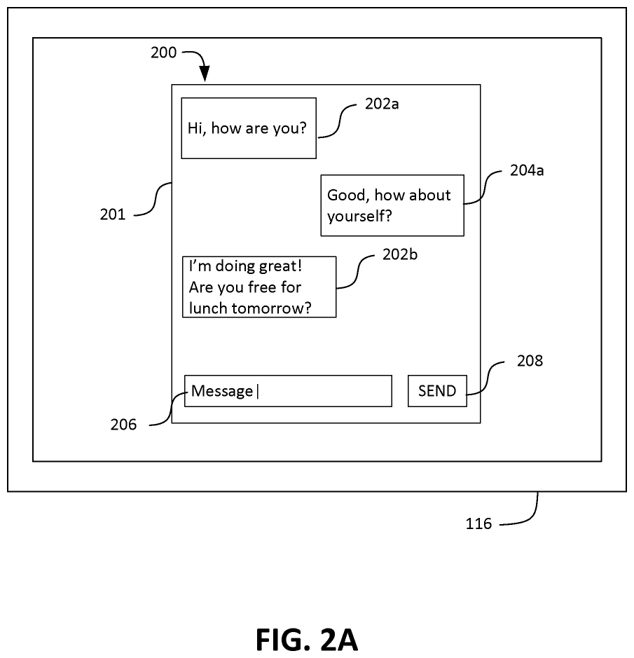

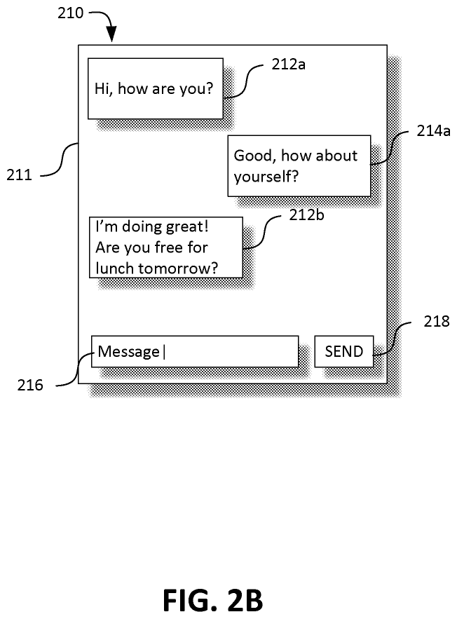

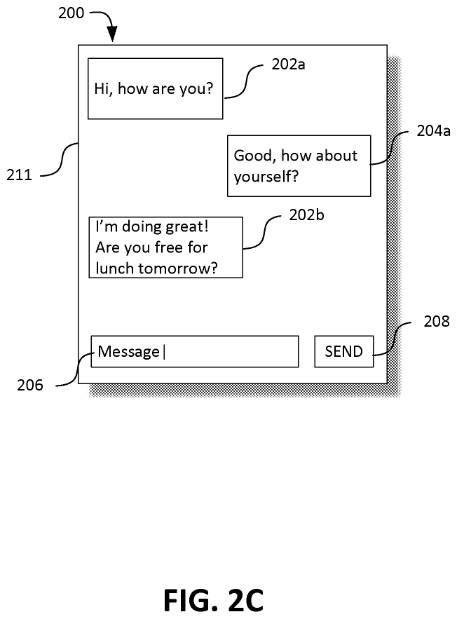

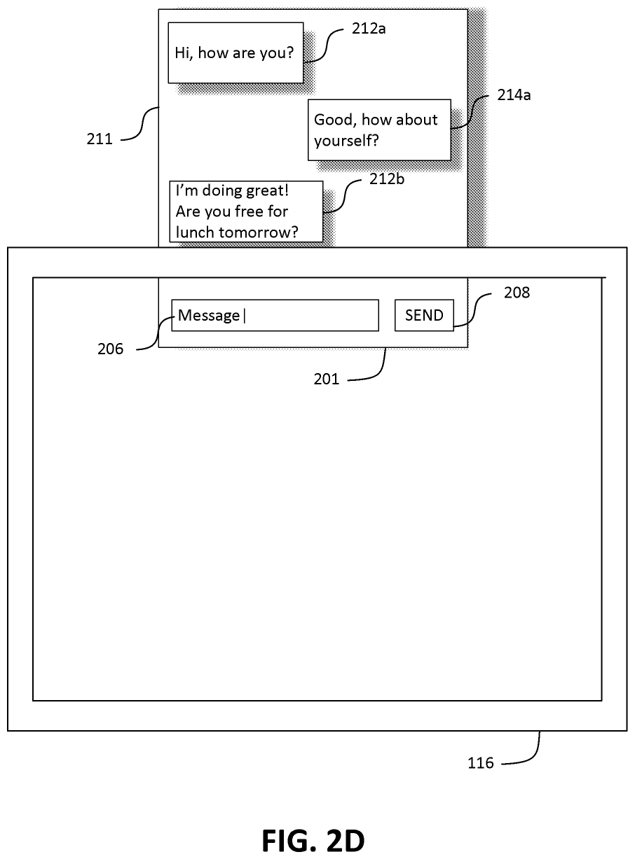

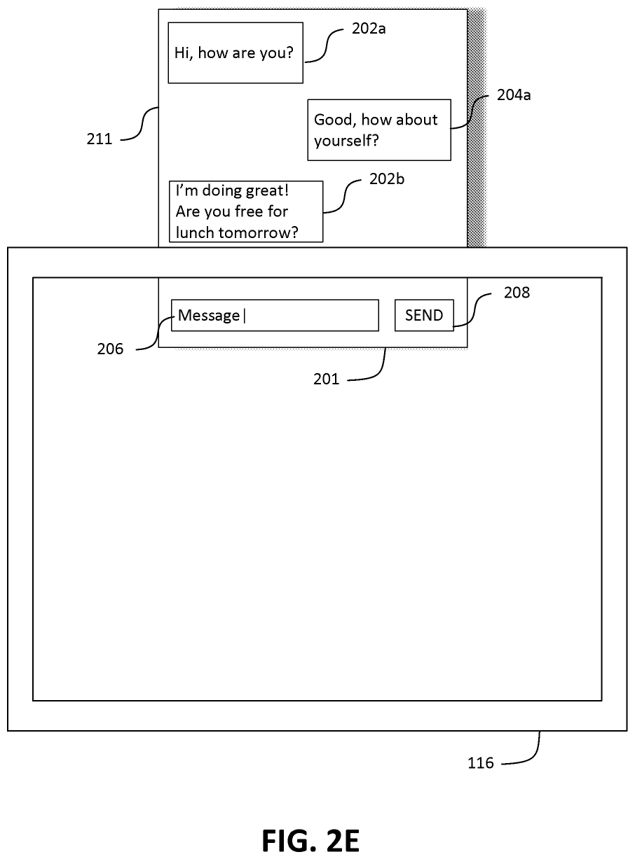

In some examples, at least a portion of the memory 102 can be referred as a computer-readable storage medium. Memory 102 and/or a transitory or non-transitory computer readable storage medium of memory 102 can store instructions 104, programs, data structures and/or modules or a subset or combination thereof in some embodiments. In some embodiments, memory 102 and/or the computer readable storage medium can store instructions 104, which when executed by processors 110, can cause the electronic device 100 (or a computing system more generally) to perform one or more functions and methods of one or more examples of this disclosure, such as one or more of the methods described in more detail below with reference to FIGS. 2-4. As used herein, a “non-transitory computer-readable storage medium” includes any tangible medium (e.g., excluding signals) that can contain or store programs/instructions for use by the electronic device (e.g., processing circuitry), for example.

In some embodiments, the electronic device 100 further includes one or more processors 110. Processors 110 can include graphics processing units (GPUs), central processing units (CPUs), microprocessors, microcontrollers, programmable logic device (PLD), field-programmable gate arrays (FPGAs), application specific integrated circuits (ASICs), digital signal processors (DSPs), or any suitable processing circuitry. The electronic device 100 can use processors 110 to perform any of the functions, processes, and/or methods described herein (e.g., optionally by executing instructions or programs stored in memory 102 and/or a non-transitory computer-readable storage medium).

In some embodiments, the electronic device 100 further includes an I/O interface 112. I/O interface 112 includes circuitry such as data lines, address lines, and control lines, for example, that enables communication between the electronic device 100 and one or more peripherals, such as two-dimensional display device 116, three-dimensional display device 117, other output device(s) 118, and input device(s) 120. Example two-dimensional display devices 116 include, but are not limited to, monitors, television screens, touch screens, projectors, and/or touch screens implemented with LCD (liquid crystal display), LED (light emitting diode), OLED (organic light emitting diode), and/or other technology. Examples of three-dimensional display devices 117 include head-mounted displays, contact lens-integrated displays, and/or hologram displays. Examples of other output device(s) 118 include, but are not limited to audio output devices (e.g., wired and/or wireless speakers and/or headphones), tactile output devices (e.g., haptic and/or vibration devices), and other visual output devices (e.g., indicator lights). Example input device(s) 120 include camera(s) (e.g., visible light cameras and/or infrared cameras), depth sensors (e.g., range sensors and/or LiDAR), trackpads, mouses, touch screens, microphones, keyboards, pedals, remote controls, and/or video game controllers. In some embodiments, the electronic device 100 is in communication with one or more of the input device(s) and/or output device(s) shown in FIG. 1 as coupled to the I/O interface 112 using wireless communication and/or connection(s). In some embodiments, the electronic device 100 is in communication with one or more of the input device(s) and/or output device(s) shown in FIG. 1 as coupled to the I/O interface 112 using wired communication and/or connection(s).

Example electronic devices 100 include laptop or desktop computers, tablets, smartphones, media players, and wearable devices (e.g., smart watches or head mounted displays). For example, electronic device 100 is a laptop computer having a two-dimensional display device 116 (e.g., a laptop display) integrated therein, and the laptop computer is in communication with a three-dimensional display device 117 (e.g., a head-mounted display). In this example, the processors 110 of the laptop computer execute one or more programs stored in the memory 102 of the laptop computer that include displaying two-dimensional and/or three-dimensional renderings of user interface elements. As another example, the electronic device 100 is a head-mounted device having a three-dimensional display device 117 (e.g., a head-mounted display) integrated therein, and the head-mounted device is in communication with a two-dimensional display device 116 (e.g., a monitor or the display of a laptop computer). In this example, the processors 110 of the head-mounted device execute one or more programs stored in the memory 102 of the head-mounted device that include displaying two-dimensional and/or three-dimensional renderings of user interface elements. In another example, the electronic device 100 is a desktop computer that is in communication with a two-dimensional display device 116 (e.g., a monitor) and a three-dimensional display device 117 (e.g., a head-mounted display). In this example, the processors 110 of the desktop computer execute one or more programs stored in the memory 102 of the desktop computer that include displaying two-dimensional and three-dimensional renderings of user interface elements.

As described above, the components and configuration of components of electronic device 100 according to the disclosure are not limited by the example illustrated and described with reference to FIG. 1. In some embodiments, one or more of the components of the electronic device 100 included in FIG. 1 and any additional components of the electronic device 100 not shown in FIG. 1 are in communication with each other and/or integrated with each other. In some embodiments, additional or alternative components and/or configurations are possible.

FIGS. 2A-2E illustrate examples of two-dimensional and three-dimensional renderings of a user interface element according to some embodiments of the disclosure. FIG. 2A illustrates an example of a two-dimensional rendering 200 of a user interface element. In some embodiments, an electronic device 100 described above with reference to FIG. 1 displays the two-dimensional rendering 200 using a two-dimensional display device 116 described above with reference to FIG. 1. In the example shown in FIG. 2A, the two-dimensional rendering 200 is a user interface of a messaging application. The two-dimensional rendering 200 can include a container 201 of the user interface (e.g., a window or backplane), representations 202a and 202b of messages received from another electronic device, a representation 204a of a message sent by the electronic device 100, a text entry field 206 into which the user can enter text for a new message, and a selectable option 208 that, when selected, causes the electronic device 100 to send the message composed in the text entry field 206 to the messaging conversation.

As shown in FIG. 2A, the two-dimensional rendering 200 of the messaging user interface includes two-dimensional user interface elements. For example, the container 201, message representations 202a, 202b, and 204a, text entry field 206, and selectable option 208 are presented in two dimensions.

In some embodiments, the electronic device 100 displays the two-dimensional rendering 200 of the messaging user interface using the two-dimensional display device 116 in accordance with one or more criteria for displaying a three-dimensional rendering (see FIG. 2B) not being satisfied. In some embodiments, the one or more criteria are not satisfied when the electronic device 100 is not in communication with a three-dimensional display device 117.

In some embodiments, the one or more criteria are not satisfied when the electronic device 100 receives a user input requesting to display the two-dimensional rendering 200 of the messaging user interface. For example, the input includes a request to display the two-dimensional rendering 200 of the messaging user interface without displaying a three-dimensional rendering of the messaging user interface. In some embodiments, as described below with reference to FIG. 2D, the electronic device 100 displays the two-dimensional rendering 200 concurrently with a three-dimensional rendering of the messaging user interface. In some embodiments, in response to receiving the input corresponding to the request to display the two-dimensional rendering 200 of the messaging user interface, the electronic device 100 displays the two-dimensional rendering 200 even if one or more of the other criteria for displaying the three-dimensional rendering are satisfied.

In some embodiments, the one or more criteria for displaying a three-dimensional rendering are not satisfied when a system setting is in place that causes the electronic device 100 to display two-dimensional renderings instead of the three-dimensional renderings. For example, even if the electronic device 100 is in communication with the three-dimensional display device 117, if the setting for displaying the two-dimensional renderings instead of three-dimensional renderings is activated, the electronic device 100 displays the two-dimensional rendering 200 instead of displaying a three-dimensional rendering of the messaging user interface. In some situations, the electronic device 100 displays the two-dimensional rendering 200 using a three-dimensional display device 117 instead of or in addition to a two-dimensional display device 116, as described in more detail below with reference to FIGS. 2C and 2E, for example.

FIG. 2B illustrates an example of a three-dimensional rendering 210 of a user interface element in accordance with some embodiments of the disclosure. In some embodiments, an electronic device 100 described above with reference to FIG. 1 displays the three-dimensional rendering 210 using a three-dimensional display device 117 described above with reference to FIG. 1. In the example shown in FIG. 2B, the three-dimensional rendering 210 is a user interface of a messaging application that corresponds to the two-dimensional rendering 200 described above with reference to FIG. 2A. For example, two-dimensional rendering 200 and three-dimensional rendering 210 are renderings of the same messaging application user interface including the same messaging conversation. The three-dimensional rendering 210 can include similar elements to the elements of the two-dimensional rendering 200, except the elements of the three-dimensional rendering 210 are three-dimensional instead of being two-dimensional. For example, the three-dimensional rendering 210 includes a container 211 of the user interface (e.g., a window or backplane), representations 212a and 212b of messages received from another electronic device, a representation 214a of a message sent by the electronic device 100, a text entry field 216 into which the user can enter text for a new message, and a selectable option 218 that, when selected, causes the electronic device 100 to send the message composed in the text entry field 216 to the messaging conversation.

In some embodiments, the three-dimensional display device 117 displays the three-dimensional rendering 210 in a three-dimensional environment. For example, the three-dimensional environment can be an XR (extended reality) environment that further includes representations of real objects in the environment of the three-dimensional display device 117 and/or electronic device 100. In some embodiments, the representations of real objects can be displayed using “optical” passthrough in which the user is able to view portions of the real environment through transparent portions of the three-dimensional display device 117. In some embodiments, the representations of real objects can be displayed using “virtual,” “video,” or “digital” passthrough in which the electronic device 100 captures one or more images of the environment of the three-dimensional display device 117 and/or the electronic device 100 using one or more cameras and displays three-dimensional images of the real objects using the three-dimensional display device 117. For example, the electronic device 100 captures the images of the real environment using one or more cameras integrated with the three-dimensional display device 117. In some embodiments, additionally or alternatively, the XR environment includes three-dimensional renderings of additional virtual objects, such as other user interface elements and/or virtual representations of real objects not present in the real environment.

In some embodiments, the three-dimensional environment can be a VR (virtual reality) environment that does not include representations of real objects in the real environment of the electronic device 100 and/or three-dimensional display device 117. For example, the electronic device 100 generates an immersive virtual environment and displays the three-dimensional rendering 210 of the messaging application in the immersive virtual environment using the three-dimensional display device 117. In some embodiments, additionally or alternatively, the VR environment includes three-dimensional renderings of additional virtual objects, such as other user interface elements and/or virtual representations of real objects not present in the real environment.

As shown in FIG. 2B, the three-dimensional rendering 210 of the messaging user interface includes three-dimensional user interface elements. For example, the container 211, message representations 212a, 212b, and 214a, text entry field 216, and selectable option 218 are displayed in three dimensions, as illustrated by the simulated shadows shown in FIG. 2B. It should be noted that, in some embodiments, container 211 is a two-dimensional container displayed in a three-dimensional environment. In some embodiments, the container 211 is a three-dimensional container with a non-zero thickness. In some embodiments, the message representations 212a, 212b, and 214a, text entry field 216, and selectable option 218 are displayed with visual separation from container 211. For example, the electronic device 101 displays simulated shadows of representations 212a, 212b, and 214a, text entry field 216, and selectable option 218 against container 211. As another example, the electronic device 101 displays representations 212a, 212b, and 214a, text entry field 216, and selectable option 218 at a between the viewpoint of the user of the electronic device 100 and the container 211 in the three-dimensional environment.

In some embodiments, the electronic device 100 displays the three-dimensional rendering 210 of the messaging user interface using the three-dimensional display device 117 in accordance with the one or more criteria for displaying a three-dimensional rendering being satisfied. As described above with reference to FIG. 2A, in some embodiments, the one or more criteria include criteria that are satisfied when the electronic device 100 is in communication with a three-dimensional display device 117, when the electronic device 100 receives a user input requesting to display the three-dimensional rendering 210 of the messaging user interface, and/or when a system setting is in place that causes the electronic device 100 to display three-dimensional renderings instead of the two-dimensional renderings. In some situations, the electronic device 100 displays the two-dimensional rendering 200 using a three-dimensional display device 117 instead of or in addition to a two-dimensional display device 116, as described in more detail below with reference to FIGS. 2C and 2E, for example.

FIG. 2C illustrates an example of a two-dimensional rendering 200 of a user interface element in accordance with some embodiments of the disclosure. In some embodiments, the electronic device 100 displays the two-dimensional rendering 200 in FIG. 2C using the three-dimensional display device 117. For example, the electronic device 100 uses the three-dimensional display device 117 to display the two-dimensional rendering 200 in a three-dimensional environment. As shown in FIG. 2C, in some embodiments, the electronic device 100 displays the two-dimensional rendering 200 of the user interface in a three-dimensional container 211. In some embodiments, the electronic device 100 displays the two-dimensional rendering 200 of the user interface in a two-dimensional container the same as or similar to two-dimensional container 201 in FIG. 2A. In some embodiments, the electronic device 100 uses the three-dimensional display device 117 to display the two-dimensional rendering 200 of the user interface element in a three-dimensional environment. In some embodiments, the electronic device 100 displays the two-dimensional rendering 200 instead of a three-dimensional rendering in response to a user input and/or because a setting is activated on the electronic device 100 that causes the electronic device 100 to forgo displaying three-dimensional renderings.

FIG. 2D illustrates an example of augmenting a two-dimensional display device 116 using a three-dimensional display device 117 in accordance with some embodiments of the disclosure. In some embodiments, the electronic device 100 simulates expanding the display area of a two-dimensional display device 116 such as a computer monitor or laptop display using a three-dimensional display device 117 such as a head-mounted display. In some embodiments, the electronic device 100 displays a three-dimensional extended reality (XR) environment using the three-dimensional display device 117 that includes portions of the physical environment of the three-dimensional display device 117 and/or the electronic device 100 as described above. In some embodiments, the two-dimensional display device 116 is included in portions of the physical environment included in the three-dimensional XR environment, and the user is able to view user interface elements displayed using the two-dimensional display device 116 within the three-dimensional XR environment. In some embodiments, the electronic device 100 extends the display area of the two-dimensional display device 116 using the three-dimensional display device 117. For example, the electronic device 100 displays portions of user interface elements that are beyond the displayable region of the two-dimensional display device 116 using the three-dimensional display device as shown in FIG. 2D.

As shown in FIG. 2D, the electronic device 100 uses the two-dimensional display device 116 to display a first portion of the user interface element in a two-dimensional container 201 and uses the three-dimensional display device 117 to display a second portion of the display device in a three-dimensional container 211, for example. In this example, the electronic device 100 displays the text entry field 206 and send option 208 in two dimensions using the two-dimensional display device and displays representations 212a, 212b, and 214a of messages in three dimensions using the three-dimensional display device 117. In some embodiments, without augmenting the two-dimensional display device 116 with the three-dimensional display device 117, a portion of the user interface element would be cut off by the boundary of the two-dimensional display device 116 if the user interface element were to be displayed at the same size and location in the two-dimensional display device 116. In some embodiments, rather than displaying user interface elements with portions displayed by the two-dimensional display device 116 and portions displayed using the three-dimensional display device 117, the electronic device 100 displays entire user interface elements either using the two-dimensional display device 116 or the three-dimensional display device 117. In some embodiments, the electronic device permits? the user is able to drag user interface elements between the display area of the two-dimensional display 116 and portions of the three-dimensional XR environment outside of the display area of the two-dimensional display 117.

FIG. 2E illustrates an example of augmenting a two-dimensional display device 116 using a three-dimensional display device in accordance with some embodiments of the disclosure. In some embodiments, the example in FIG. 2E is similar to the example in FIG. 2D, except the portion of the user interface element that the electronic device 100 displays using the three-dimensional display device 117 is displayed in two dimensions. For example, the electronic device 100 displays the representations 202a, 202b, and 204a of messages in two dimensions using the three-dimensional display device 117. In some embodiments, as shown in FIG. 2E, the three-dimensional display device 117 displays the representations 202a, 202b, and 204a of the messages in a three-dimensional container 211. In some embodiments, the three-dimensional display device 117 displays the representations 202a, 202b, and 204a of the messages in a two-dimensional container.

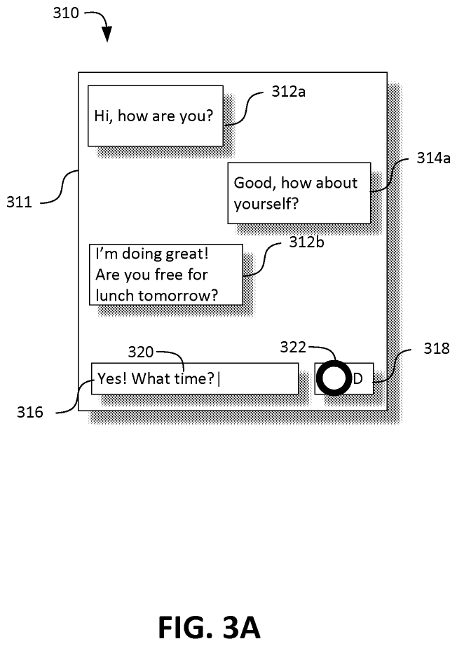

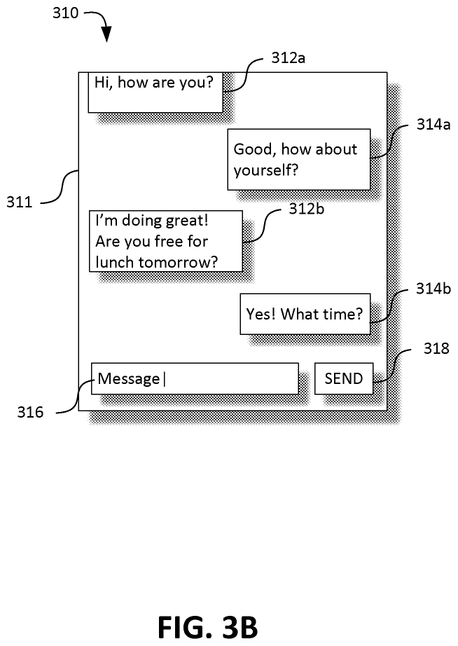

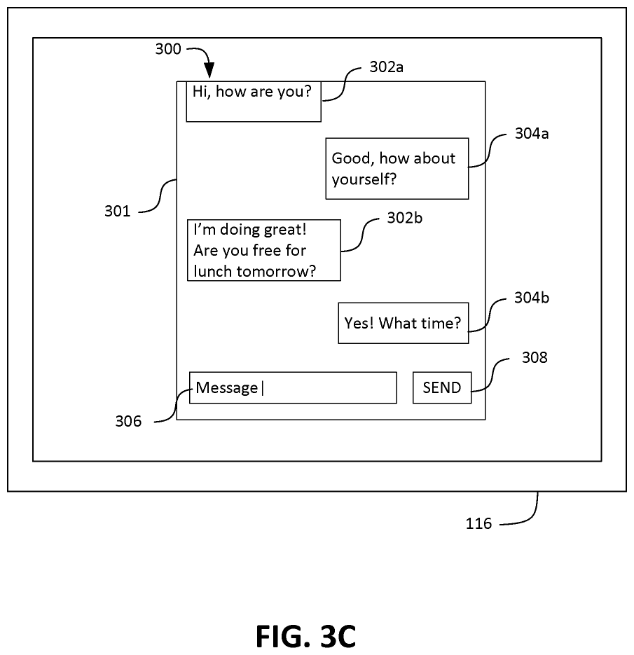

FIGS. 3A-3C illustrate examples of preserving changes to a user interface when transitioning between displaying a two-dimensional representation of the user interface and displaying a three-dimensional rendering of the user interface in accordance with some embodiments of the disclosure. Referring to FIG. 3A, the electronic device 100 uses the three-dimensional display device 117 to display a three-dimensional rendering 310 of a messaging user interface that is the same as or similar to the messaging user interface described above with reference to FIGS. 2A-2E in some embodiments. For example, the three-dimensional rendering 310 includes a container 311 similar to container 211, representations 312a, 312b, and 314a of messages similar to representations 212a, 212b, and 214a, a text entry field 316 similar to text entry field 216, and a send option 318 similar to send option 218.

As shown in FIG. 3A, for example, the text entry field 316 includes text 320 the user previously provided to the electronic device 100. In some embodiments, the text 320 is a draft of a message to be sent to the messaging conversation. In some embodiments, the electronic device 100 enters text 320 into the text entry field 316 in response to a sequence of inputs received using an input device (e.g., a hardware keyboard, a soft keyboard, or a voice input interface). In some embodiments, the electronic device 100 receives an input 322 selecting the send option 318 while the text entry field 316 includes the text 320. In some embodiments, the input 322 is received using a mouse trackpad, touch screen, or another input device in communication with the electronic device 100. In some embodiments, the input 322 is a gesture detected by a touch screen, trackpad and/or one or more cameras. In response to the input in FIG. 3A, the electronic device 100 sends a message to the messaging conversation including text 320 as shown in FIG. 3B.

FIG. 3B illustrates an example of an updated version of the three-dimensional rendering 310 of the user interface in accordance with some embodiments of the disclosure. As shown in FIG. 3B, the updated version of the three-dimensional rendering 310 of the user interface includes a representation 314b of the message the electronic device 100 sent to the messaging conversation in response to the input in FIG. 3A. For example, the electronic device updates the three-dimensional rendering 310 of the messaging conversation in FIG. 3B because the electronic device updates the messaging conversation in response to receiving the input to send the message corresponding to representation 314b. As shown in FIG. 3B, the representation 314b of the message includes the text that was displayed in the text entry field 316 in FIG. 3A. In some embodiments, if the electronic device 100 displays a two-dimensional rendering of the messaging user interface after the user sent the message corresponding to representation 314b, the two-dimensional rendering of the messaging user interface will include a two-dimensional representation 304b of the message, as shown in FIG. 3C.

FIG. 3C illustrates an example of an updated version of the two-dimensional rendering 300 in accordance with some embodiments of the disclosure. The updated version of the two-dimensional rendering 300 optionally corresponds to the updated messaging conversation; that is, the messaging conversation updated in response to receiving the input corresponding to a request to send a message to the conversation. In some embodiments, two-dimensional rendering 300 corresponds to the three-dimensional rendering 310 described above with reference to FIGS. 3A-3B. For example, the three-dimensional rendering 310 of the messaging user interface includes representations 302a, 302b, 304a, and 304b of messages in the messaging conversation, text entry field 306, send option 308, and container 301. In some embodiments, in response to the user sending a message to the messaging conversation using the two-dimensional rendering 300 of the messaging user interface, the electronic device 100 will likewise display a representation of the new message when displaying the three-dimensional rendering 310 of the messaging user interface after the message was sent. Moreover, in some embodiments, if the messaging conversation is updated in other ways, such as the device 100 receiving a new message or one or more messages being deleted from the messaging conversation, those updates will be made to the two-dimensional rendering 300 and the three-dimensional rendering 310 of the messaging conversation irrespective of which rendering was displayed when the change was detected by the electronic device 100. Thus, in some embodiments, when the electronic device updates a virtual object (e.g., the messaging conversation) while displaying the two-dimensional rendering or the three-dimensional rendering of that virtual object, the electronic device updates both the two-dimensional rendering and the three-dimensional rendering of the virtual object.

Although various examples have been described with respect to the messaging user interface shown in FIGS. 2A-3C, it should be understood that the disclosure is not limited to messaging user interfaces. In some embodiments, one or more of the techniques described above can be applied to other user interface elements, including user interfaces of other applications, portions of user interfaces, and other virtual objects.

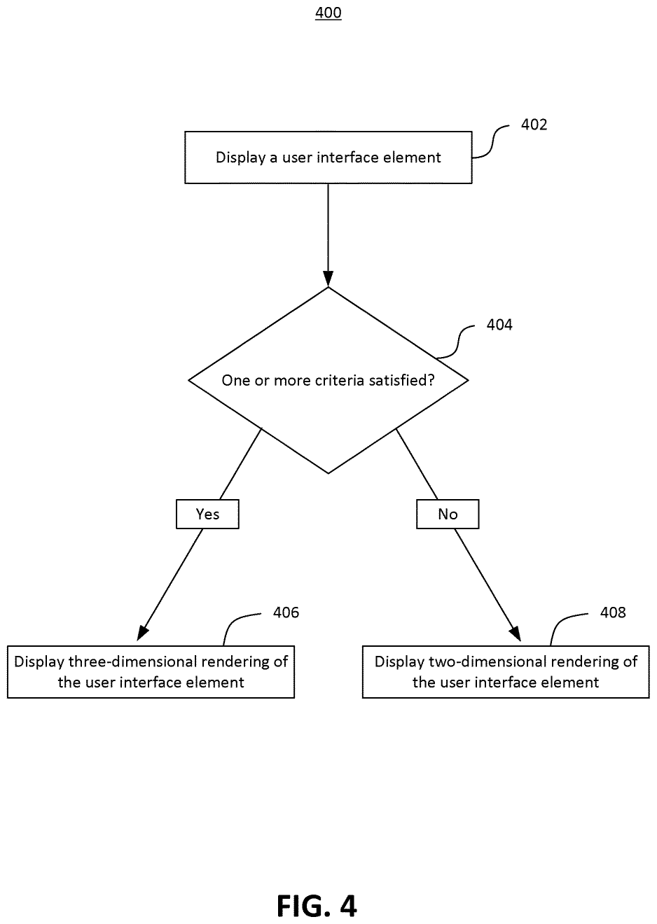

FIG. 4 is a block diagram illustrating an example method 400 performed by an electronic device 100 in accordance with some embodiments of the disclosure. For example, electronic device 100 described above with reference to FIG. 1 performs method 400 to determine whether to display a user interface element as a three-dimensional rendering or as a two-dimensional rendering. In some embodiments, performing the method 400 includes performing one or more operations described above with reference to FIGS. 2A-3C.

At block 402, the electronic device 100 displays a user interface element in some embodiments. For example, the user interface element is the messaging user interface described above with reference to FIGS. 2A-3C. As described above with reference to FIGS. 2A-3C and in more detail below, displaying the user interface element includes displaying a two-dimensional rendering of the user interface element and/or a three-dimensional rendering of the user interface element depending on whether one or more criteria are satisfied.

At block 404, in some embodiments, the electronic device 100 determines whether one or more criteria are satisfied. For example, the one or more criteria are one or more criteria for displaying a three-dimensional rendering of the user interface element instead of a two-dimensional rendering of the user interface element. In some embodiments, the one or more criteria include one or more of the following: receiving a user input that corresponds to a request to display the user interface element as a three-dimensional rendering, a three-dimensional display device 117 being in communication with the electronic device 100, and/or a setting or mode for displaying three-dimensional renderings being activated on the electronic device 100.

At block 406, in some embodiments, in response to the one or more criteria being satisfied (e.g., “yes” at block 404), the electronic device 100 displays the three-dimensional rendering of the user interface element. For example, while the electronic device 100 is in communication with the three-dimensional display device 117, in response to receiving an input to display a user interface element in three dimensions, the electronic device 100 displays the three-dimensional rendering of the user interface element. As another example, while the electronic device 100 is in communication with the three-dimensional display device 117 and in a mode where the electronic device 100 defaults to displaying user interface elements in three dimensions, the electronic device 100 displays the three-dimensional rendering of the user interface element.

At block 408, in some embodiments, in response to the one or more criteria not being satisfied (e.g., “no” at block 408), the electronic device 100 displays the two-dimensional rendering of the user interface element. For example, if the electronic device 100 is not in communication with the three-dimensional display device 117, the electronic device 100 uses the two-dimensional display device 116 to display the two-dimensional rendering of the user interface element. As another example, irrespective of whether electronic device 100 is in communication with the electronic device 100, if a mode for displaying user interface elements in three dimensions is not activated and the electronic device 100 does not receive an input corresponding to a request to display the user interface element in three dimensions, the electronic device 100 displays the two-dimensional rendering of the user interface element. In this example, the electronic device 100 can use the two-dimensional display device 116 to display the two-dimensional rendering or, if the electronic device 100 is in communication with the three-dimensional display device 117, the electronic device 100 can use the three-dimensional display device 117 and/or the two-dimensional display device 116 to display the two-dimensional rendering.

Therefore, according to the above, some embodiments are directed to An electronic device comprising: memory; and one or more processors coupled to the memory and to one or more output devices, the one or more processors configured to: while the electronic device is in communication with a two-dimensional display device and a three-dimensional display device included in the one or more output devices, display, using the one or more output devices, a user interface element associated with an application running on the electronic device, including: in accordance with a determination that one or more criteria are satisfied, transmitting instructions to the three-dimensional display device to display a three-dimensional rendering of the user interface element; and in accordance with a determination that the one or more criteria are not satisfied, transmitting instructions to the two-dimensional display device to display a two-dimensional rendering of the user interface element. Additionally or alternatively, in some embodiments the one or more processors are configured to: while displaying the three-dimensional rendering of the user interface element using the three-dimensional display device, receive, from the three-dimensional display device, an indication of an update to the three-dimensional rendering of the user interface element; and in response to receiving the indication of the update to the three-dimensional rendering of the user interface element, update the two-dimensional rendering of the user interface element in a manner corresponding to the update to the three-dimensional rendering of the user interface element. Additionally or alternatively, in some embodiments the one or more processors are further configured to in accordance with a determination that one or more second criteria are satisfied, transmit instructions to the three-dimensional display device to display the two-dimensional rendering of the user interface element in a three-dimensional environment. Additionally or alternatively, in some embodiments the one or more processors are further configured to: while displaying the three-dimensional rendering of the user interface element using the three-dimensional display device, receive, using one or more input devices in communication with the electronic device, a user input corresponding to a request to display the two-dimensional rendering of the user interface element; and in response to receiving the user input, transmit second instructions to display the two-dimensional rendering of the user interface element. Additionally or alternatively, in some embodiments transmitting the second instructions to display the two-dimensional rendering of the user interface element includes transmitting the second instructions to display the two-dimensional rendering of the user interface element to the two-dimensional display device. Additionally or alternatively, in some embodiments transmitting the second instructions to display the two-dimensional rendering of the user interface element includes transmitting the second instructions to display the two-dimensional rendering of the user interface element to the three-dimensional display device. Additionally or alternatively, in some embodiments the second instructions to display the two-dimensional rendering of the user interface element are instructions to display the two-dimensional rendering of the user interface element with the three-dimensional display device as an augmentation of the two-dimensional display device. Additionally or alternatively, in some embodiments the one or more processors are further configured to while displaying the two-dimensional rendering of the user interface element, receive, using one or more input devices in communication with the electronic device, a user input corresponding to a request to display the three-dimensional rendering of the user interface element and in response to receiving the user input, transmit second instructions to the three-dimensional display device to display the three-dimensional rendering of the user interface element. Additionally or alternatively, in some embodiments the one or more criteria include a criterion that is satisfied when the electronic device is in communication with the three-dimensional display device. Additionally or alternatively, in some embodiments the one or more processors are configured to: while the one or more criteria are not satisfied, and while displaying the two-dimensional rendering of the user interface element, detect the one or more criteria transition from being not satisfied to being satisfied, and in response to detecting the one or more criteria transition from being not satisfied to being satisfied, transmit instructions to the three-dimensional display device to: display an animated transition from displaying the two-dimensional rendering of the user interface element to displaying the three-dimensional rendering of the user interface element, and after displaying the animated transition, display the three-dimensional rendering of the user interface element. Additionally or alternatively, in some embodiments, the one or more processors are further configured to receive an indication to update data represented by the user interface element; in response to receiving the indication to update the data represented by the user interface element, update the data represented by the user interface element; update the two-dimensional rendering of the user interface element in accordance with the indication; and update the three-dimensional rendering of the user interface element in accordance with the indication

Some embodiments are directed to a method comprising: at an electronic device including memory and one or more processors coupled to the memory and to one or more output devices: while the electronic device is in communication with a two-dimensional display device and a three-dimensional display device included in the one or more output devices, displaying, using the one or more output devices, a user interface element associated with an application running on the electronic device, including in accordance with a determination that one or more criteria are satisfied, transmitting instructions to the three-dimensional display device to display a three-dimensional rendering of the user interface element; and in accordance with a determination that the one or more criteria are not satisfied, transmitting instructions to the two-dimensional display device to display a two-dimensional rendering of the user interface element.

Some embodiments are directed to a non-transitory computer readable storage medium storing instructions that, when executed by an electronic device including memory and one or more processors coupled to the memory and to one or more output devices, causes the electronic device to: while the electronic device is in communication with a two-dimensional display device and a three-dimensional display device included in the one or more output devices, display, using the one or more output devices, a user interface element associated with an application running on the electronic device, including in accordance with a determination that one or more criteria are satisfied, transmitting instructions to the three-dimensional display device to display a three-dimensional rendering of the user interface element; and in accordance with a determination that the one or more criteria are not satisfied, transmitting instructions to the two-dimensional display device to display a two-dimensional rendering of the user interface element.

Technology implementors are reminded that sharing data between electronic devices should be performed in accordance with privacy practices meeting or exceeding applicable laws and/or industry standards. These privacy practices may include, but are not limited to, requiring user permission to share the data and/or permitting the user to opt-out of processing and/or storing some or all of the data and/or anonymizing the data, and so forth. For example, implementers of devices may explain in its user interface and documentation the device's ability to share and receive data, and require appropriate parties to opt-in before sharing data.

1. An electronic device comprising:
memory; and
one or more processors coupled to the memory and to one or more output devices, the one or more processors configured to:
while the electronic device is in communication with a two-dimensional display device and a three-dimensional display device included in the one or more output devices, display, using the one or more output devices, content associated with an application running on the electronic device, including:
in accordance with a determination that one or more criteria are satisfied, transmitting instructions to the three-dimensional display device to display a three-dimensional rendering of the content;
in accordance with a determination that the one or more criteria are not satisfied, transmitting instructions to the two-dimensional display device to display a two-dimensional rendering of the content; and
in accordance with a determination that one or more second criteria are satisfied, transmitting instructions to the three-dimensional display device to display a first portion of the content in a three-dimensional container, and to display a second portion of the content in a two-dimensional container.

2. The electronic device of claim 1, wherein the one or more processors are configured to:
while displaying the three-dimensional rendering of the content using the three-dimensional display device, receive, from the three-dimensional display device, an indication of an update to the three-dimensional rendering of the content; and
in response to receiving the indication of the update to the three-dimensional rendering of the content, update the two-dimensional rendering of the content in a manner corresponding to the update to the three-dimensional rendering of the content.

3. The electronic device of claim 1, wherein the one or more processors are further configured to:
in accordance with a determination that one or more third criteria are satisfied, transmit instructions to the three-dimensional display device to display the two-dimensional rendering of the content in a three-dimensional environment.

4. The electronic device of claim 1, wherein the one or more processors are further configured to:
while displaying the three-dimensional rendering of the content using the three-dimensional display device, receive, using one or more input devices in communication with the electronic device, a user input corresponding to a request to display the two-dimensional rendering of the content; and
in response to receiving the user input, transmit second instructions to display the two-dimensional rendering of the content.

5. The electronic device of claim 4, wherein transmitting the second instructions to display the two-dimensional rendering of the content includes transmitting the second instructions to display the two-dimensional rendering of the content to the two-dimensional display device.

6. The electronic device of claim 4, wherein transmitting the second instructions to display the two-dimensional rendering of the content includes transmitting the second instructions to display the two-dimensional rendering of the content to the three-dimensional display device.

7. The electronic device of claim 1, wherein the one or more processors are further configured to:
while displaying the two-dimensional rendering of the content, receive, using one or more input devices in communication with the electronic device, a user input corresponding to a request to display the three-dimensional rendering of the content; and
in response to receiving the user input, transmit second instructions to the three-dimensional display device to display the three-dimensional rendering of the content.

8. The electronic device of claim 1, wherein the one or more criteria include a criterion that is satisfied when the electronic device is in communication with the three-dimensional display device.

9. The electronic device of claim 1, wherein the one or more processors are configured to:
while the one or more criteria are not satisfied, and while displaying the two-dimensional rendering of the content, detect the one or more criteria transition from being not satisfied to being satisfied, and
in response to detecting the one or more criteria transition from being not satisfied to being satisfied, transmit instructions to the three-dimensional display device to:
display an animated transition from displaying the two-dimensional rendering of the content to displaying the three-dimensional rendering of the content, and
after displaying the animated transition, display the three-dimensional rendering of the content.

10. The electronic device of claim 1, wherein the one or more processors are further configured to:
receive an indication to update data represented by the content;
in response to receiving the indication to update the data represented by the content,
update the data represented by the content;
update the two-dimensional rendering of the content in accordance with the indication; and
update the three-dimensional rendering of the content in accordance with the indication.

11. A method comprising:
at an electronic device including memory and one or more processors coupled to the memory and to one or more output devices:
while the electronic device is in communication with a two-dimensional display device and a three-dimensional display device included in the one or more output devices, displaying, using the one or more output devices, content associated with an application running on the electronic device, including:
in accordance with a determination that one or more criteria are satisfied, transmitting instructions to the three-dimensional display device to display a three-dimensional rendering of the content;
in accordance with a determination that the one or more criteria are not satisfied, transmitting instructions to the two-dimensional display device to display a two-dimensional rendering of the content; and
in accordance with a determination that one or more second criteria are satisfied, transmitting instructions to the three-dimensional display device to display a first portion of the content in a three-dimensional container, and to display a second portion of the content in a two-dimensional container.

12. The method of claim 11, further comprising:
while displaying the three-dimensional rendering of the content using the three-dimensional display device, receiving, from the three-dimensional display device, an indication of an update to the three-dimensional rendering of the content; and
in response to receiving the indication of the update to the three-dimensional rendering of the content, updating the two-dimensional rendering of the content in a manner corresponding to the update to the three-dimensional rendering of the content.

13. The method of claim 11, further comprising:
in accordance with a determination that one or more third criteria are satisfied, transmitting instructions to the three-dimensional display device to display the two-dimensional rendering of the content in a three-dimensional environment.

14. The method of claim 11, further comprising:
while displaying the three-dimensional rendering of the content using the three-dimensional display device, receiving, using one or more input devices in communication with the electronic device, a user input corresponding to a request to display the two-dimensional rendering of the content; and
in response to receiving the user input, transmitting second instructions to display the two-dimensional rendering of the content.

15. The method of claim 14, wherein transmitting the second instructions to display the two-dimensional rendering of the content includes transmitting the second instructions to display the two-dimensional rendering of the content to the three-dimensional display device.

16. The method of claim 11, wherein the one or more criteria include a criterion that is satisfied when the electronic device is in communication with the three-dimensional display device.

17. The method of claim 11, further comprising:
while the one or more criteria are not satisfied, and while displaying the two-dimensional rendering of the content, detecting the one or more criteria transition from being not satisfied to being satisfied, and
in response to detecting the one or more criteria transition from being not satisfied to being satisfied, transmitting instructions to the three-dimensional display device to:
display an animated transition from displaying the two-dimensional rendering of the content to displaying the three-dimensional rendering of the content, and
after displaying the animated transition, display the three-dimensional rendering of the content.

18. The method of claim 11, further comprising:
receiving an indication to update data represented by the content;
in response to receiving the indication to update the data represented by the content,
updating the data represented by the content;
updating the two-dimensional rendering of the content in accordance with the indication; and
updating the three-dimensional rendering of the content in accordance with the indication.

19. A non-transitory computer readable storage medium storing instructions that, when executed by an electronic device including memory and one or more processors coupled to the memory and to one or more output devices, causes the electronic device to:
while the electronic device is in communication with a two-dimensional display device and a three-dimensional display device included in the one or more output devices, display, using the one or more output devices, content associated with an application running on the electronic device, including:
in accordance with a determination that one or more criteria are satisfied, transmit instructions to the three-dimensional display device to display a three-dimensional rendering of the content;
in accordance with a determination that the one or more criteria are not satisfied, transmit instructions to the two-dimensional display device to display a two-dimensional rendering of the content; and
in accordance with a determination that one or more second criteria are satisfied, transmit instructions to the three-dimensional display device to display a first portion of the content in a three-dimensional container, and to display a second portion of the content in a two-dimensional container.

20. The non-transitory computer readable storage medium of claim 19, wherein the instructions, when executed by the electronic device, further cause the electronic device to:
while displaying the three-dimensional rendering of the content using the three-dimensional display device, receive, from the three-dimensional display device, an indication of an update to the three-dimensional rendering of the content; and
in response to receiving the indication of the update to the three-dimensional rendering of the content, update the two-dimensional rendering of the content in a manner corresponding to the update to the three-dimensional rendering of the content.
